(19) United States
(12) Patent Application Publication
(10) Pub. No.: US 2007/0236653 A1
(43) Pub. Date: Oct. 11, 2007

(54) Interchangeable spectacles and clip-on assembly

(76) Inventors: Suk-Jae Lee, Daegu (KR); Ju-Jae Lee, Daegu (KR); Hyun-Jun Lee, Daegu (KR); Sung-Jun Lee, Daegi (KR)

Correspondence Address: ST. ONGE STEWARD JOHNSTON & REENS, LLC, 986 BEDFORD STREET, STAMFORD, CT, 06905-5619, US

(21) Appl. No.: 11/483,761

(22) Filed: Jul. 10, 2006

(30) Foreign Application Priority Data
Apr. 7, 2006 (KR) 10-2006-0032014

(51) Int. Cl. G02C 9/00

(52) U.S. Cl. 351/47

(57) ABSTRACT

Disclosed herein is an interchangeable spectacles and clip-on assembly. The interchangeable spectacles and clip-on assembly comprises a spectacle unit including a pair of prescription lenses, a frame unit configured to be detachably attached to the spectacle unit and adapted to serve as a framework constituting spectacles, and a clip-on including a pair of sunshade lenses and adapted to be detachably attached to the spectacles consisting of the spectacle unit and frame unit, to selectively serve as sunglasses. The frame unit includes a pair of U-shaped or inverted U-shaped lens frames having an open upper or lower end and intended so as not to receive lenses, and a frame bridge to connect the lens frames to each other. A frame magnet is fixed at each outer end of the frame unit, a spectacle magnet is fixed at each outer end of the spectacle unit, and a clip magnet is fixed at each outer end of the clip-on.

### CROSS-REFERENCE TO RELATED APPLICATIONS

The present application claims priority of Korean Patent Application No. 10-2006-0032014 filed Apr. 7, 2006, the content of which is incorporated herein by reference.

### FIELD OF THE INVENTION

The present invention relates to an interchangeable spectacles and clip-on assembly, and more particularly, to an interchangeable spectacles and clip-on assembly in which a spectacle unit, frame unit, and clip-on are separately prepared to have a variety of shapes and inter-attachment structures, respectively, and thus, can be freely recombined to satisfy the wearer's taste and use purpose, resulting in a variety of combinations of spectacles and clip-on.

### BACKGROUND OF THE INVENTION

Recently, the complex use environment of spectacles has increased necessity for a combination of corrective spectacles and non-corrective sunglasses.

Conventionally, the corrective spectacles and the non-corrective sunglasses have been separately prepared, so as to be selectively used in accordance with the wearer's use environment. However, such a use of the corrective spectacles or the non-corrective sunglasses may cause a lot of inconvenience under rapidly changing circumstances, for example, in the case of driving or participating in a variety of outdoor sports. Since most spectacles are configured such that prescription lenses are permanently fixed to a spectacle frame, it is impossible to freely change the configuration of the spectacles in accordance with the wearer's taste and wearing environment.

### SUMMARY OF THE INVENTION

It is an object of the present invention to provide an interchangeable spectacles and clip-on assembly in which a spectacle unit, frame unit, and clip-on having sunshade lenses serving as sunglasses are separately prepared to have a variety of shapes and inter-attachment structures, respectively, so as to be freely recombined in accordance with the wearer's taste and use purpose, thereby achieving many advantages including a variety of wearing effects, simplified compact configuration, and outstanding appearance design of the interchangeable spectacles and clip-on assembly.

It is another object of the present invention to provide an interchangeable spectacles and clip-on assembly in which a spectacle unit, frame unit, and clip-on can be detachably attached to one another by means of magnets, thereby achieving a remarkably simplified attachment configuration and increased convenience of use of interchangeable spectacles and clip-on assembly.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view illustrating an interchangeable spectacles and clip-on assembly in accordance with a first embodiment of the present invention;

FIG. 2 is a partial enlarged perspective view illustrating the attachment of magnets provided in the interchangeable spectacles and clip-on assembly of FIG. 1;

FIG. 3 is an exploded perspective view illustrating an interchangeable spectacles and clip-on assembly in accordance with a second embodiment of the present invention;

FIG. 4 is a partial enlarged perspective view illustrating the attachment of magnets provided in the interchangeable spectacles and clip-on assembly of FIG. 3, in particular, the circle A illustrating an alternative configuration in partial enlarged perspective view;

FIG. 5 is an exploded perspective view illustrating an interchangeable spectacles and clip-on assembly in accordance with a third embodiment of the present invention and, in particular, the circle A illustrating an alternative configuration in partial enlarged perspective view; and

FIG. 6 is an exploded perspective view illustrating an interchangeable spectacles and clip-on assembly in accordance with a fourth embodiment of the present invention.

### DETAILED DESCRIPTION OF THE INVENTION

Now, an interchangeable spectacles and clip-on assembly of the present invention will be described in detail with reference to the annexed drawings.

In the following description, since left and right sides of a spectacle unit, frame unit, and clip-on are symmetrical, only one side will be explained and designated by reference numerals except for lenses. Further, the corresponding constituent elements of different embodiments will be designated by the same reference numerals.

The interchangeable spectacles and clip-on assembly of the present invention basically comprises a spectacle unit 1, a frame unit 100 configured to be detachably attached to the spectacle unit 1 to thereby complete spectacles S, and a clip-on 200 configured to be detachably attached to the assembly of the spectacle unit 1 and frame unit 100 to thereby serve as sunglasses as occasion demands. To accomplish the detachable attachment between the spectacle unit 1, frame unit 100, and clip-on 200, magnets are provided in the above respective constituent elements such that magnets having opposite polarities face each other.

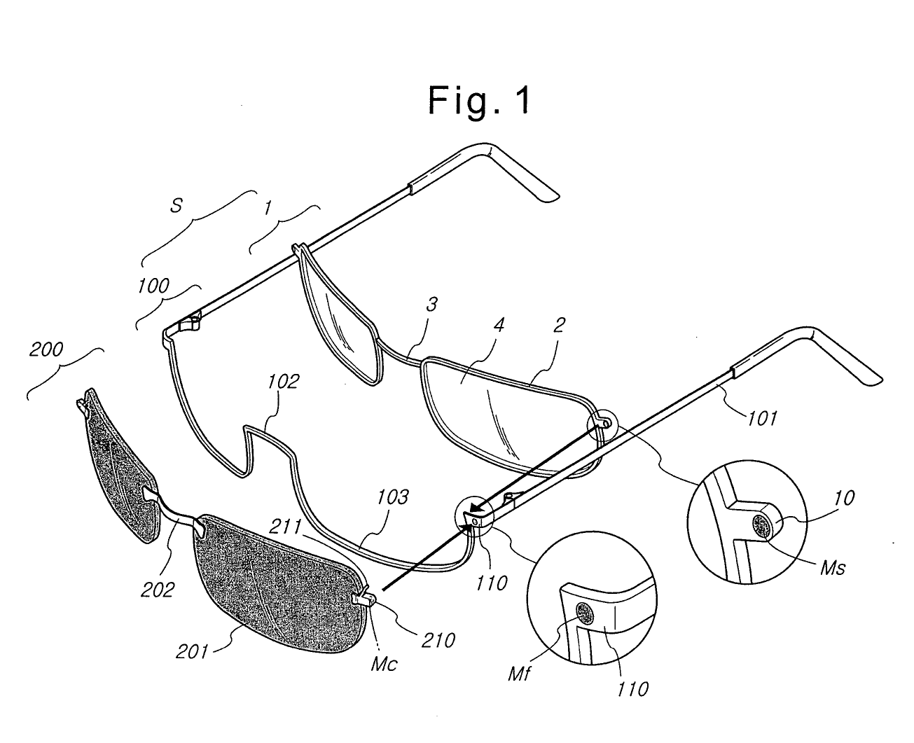

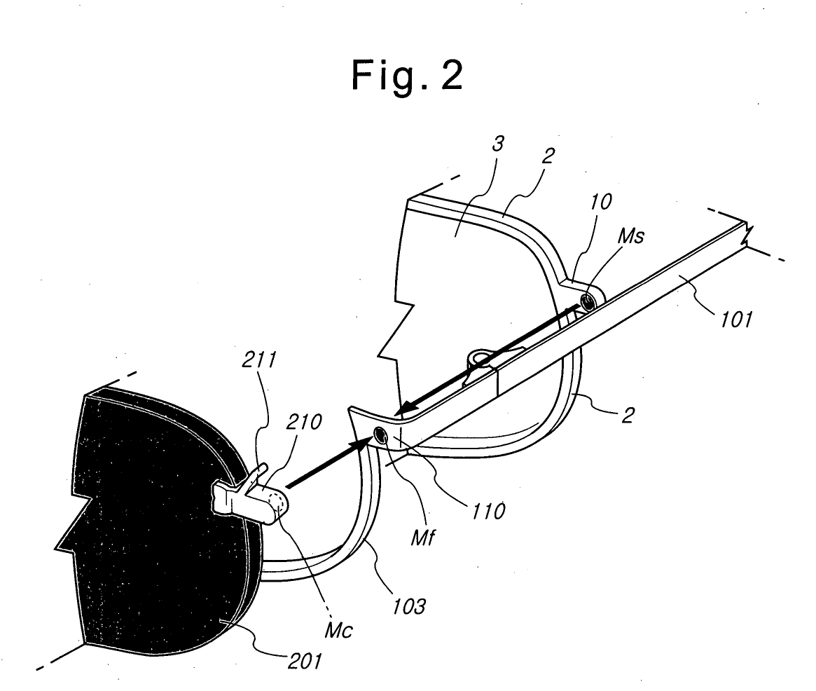

Now, the configuration of the interchangeable spectacles and clip-on assembly according to a first embodiment of the present invention will be explained with reference to FIGS. 1 and 2.

As shown in FIGS. 1 and 2, of the above mentioned basic constituent elements, the frame unit 100, forming a framework of the assembly, includes a lens frame 103, a frame bridge 102 integrally formed with the lens frame 103 to connect a pair of lens frames 103 to each other, and a temple arm 101 connected to an outer end of the lens frame 103. The frame unit 100 of the present invention is not designed to receive spectacle lenses, but is designed to provide only a basic framework for allowing both the spectacle unit 1 and clip-on 200 to be detachably attached thereto.

The lens frame 103 has a U-shaped form with an open upper end, to achieve a reduced weight and compact overall configuration of the frame unit 100. The U-shaped form of the lens frame 103 is also advantageous in that it provides the frame unit 100 with a harmonized appearance when it is attached to the spectacle unit 1.

In the present embodiment, the lens frame 103 is connected to the temple arm 101 by use of an L-shaped protruding hinge leg 110 fixed at an outer end of the lens frame 103. Of course, the connection between the lens frame 103 and the temple arm 101 is not limited to the above described hinge configuration, and other integral connectors may be used to connect the lens frame 103 to the temple arm 101.

The frame unit 100 further includes a frame magnet Mf inserted in the protruding hinge leg 110. Specifically, the frame magnet Mf is horizontally inserted through the hinge leg 110 that is used to connect the lens frame 103 to the temple arm 101. Alternatively, instead of using the frame magnet Mf, the hinge leg 110 may be magnetized to serve as a magnet itself.

The spectacle unit 1 is configured to be magnetically attached to the frame unit 100 at a rear side of the frame unit 100 (namely, at the user's side), to complete the spectacles S. The spectacle unit 1 includes a spectacle lens frame 2 configured to receive one of a pair of prescription lenses 4, and a spectacle bridge 3 integrally fixed to the spectacle lens frame 2 to connect a pair of the lens frames 2 to each other. In this case, it is noted that the spectacle unit 1 has no temple arms. The spectacle unit 1 further includes a protruding leg 10 provided at an outer end of the spectacle lens frame 2, and a spectacle magnet Ms inserted in the protruding leg 10. Specifically, the spectacle magnet Ms is inserted in a front surface of the protruding leg 10 to face the frame unit 100. Alternatively, the protruding leg 10 may be magnetized to serve as a magnet itself.

Once the frame magnet Mf of the frame unit 100 is attached to the spectacle magnet Ms of the spectacle unit 1 to complete the spectacles S, the clip-on 200, which can serve as sunglasses, is able to be attached to a front side of the spectacles S.

The configuration of the clip-on 200 is selectable from among a variety of designs. In one preferred exemplary configuration as shown in FIGS. 1 and 2, the clip-on 200 includes a pair of plate-shaped sunshade lenses 201 and a clip bridge 202 to directly connect the sunshade lenses 201 to each other, and thus, includes no lens frame. Such a frameless structure is advantageous to achieve a reduction in the overall weight of the clip-on 200. The clip-on 200 further includes a protruding rib 210 formed via an injection molding process and fixed at an outer end of each sunshade lens 201, and a clip magnet Mc inserted in the protruding rib 210. Specifically, the clip magnet Mc is inserted in a rear surface of the protruding rib 210 to face the spectacles S.

Preferably, a holding hook 211 may be additionally provided at an upper end of the protruding rib 210 to achieve a mechanical coupling between the clip-on 200 and the spectacles S.

In the above described magnet arrangement of the present embodiment, the clip magnet Mc, frame magnet Mf, and spectacle magnet Ms are aligned in a horizontal line such that the clip magnet Mc and spectacle magnet Ms are attached to front and rear sides of the frame magnet Mf.

As will be easily understood from the above description, the clip-on 200, frame unit 100, and spectacle unit 1 according to the present invention can be freely recombined in accordance with the wearer's use environment, to constitute the spectacles S or sunglasses attached to the spectacles S. In this structure, the spectacles 1 can be configured to have a desired design selected from among a variety of designs by changing the shape of the spectacle unit 1, to satisfy the wearer's taste. In this point, the spectacles and clip-on assembly of the present invention is particularly useful to persons who require corrective spectacles.

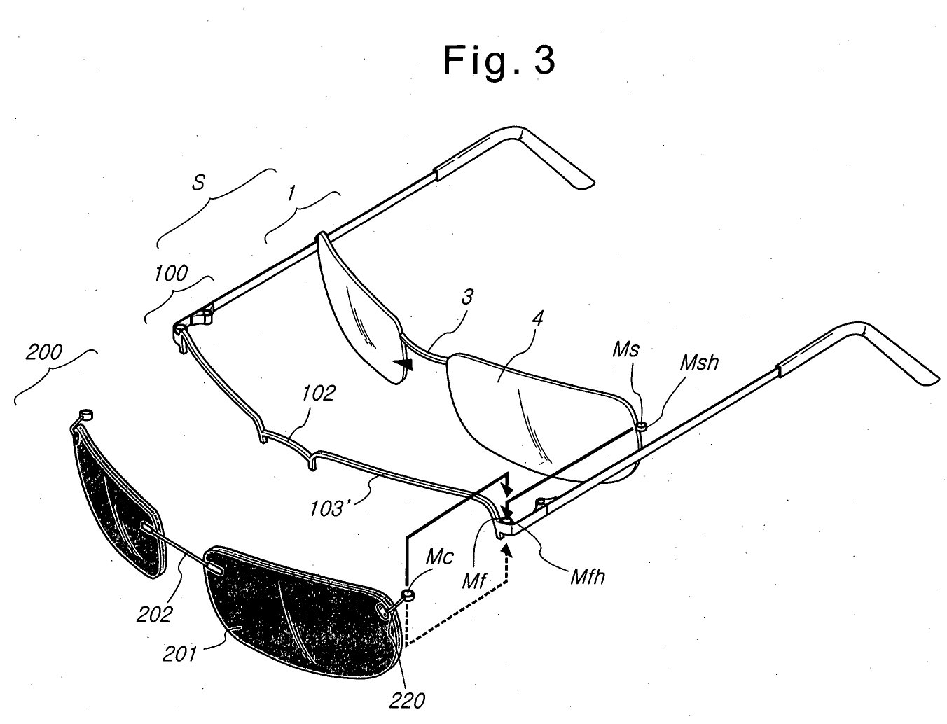

Now, second and third embodiments of the present invention, which have the same technical idea as the above described first embodiment except for some altered elements, will be explained with reference to FIGS. 3 to 6.

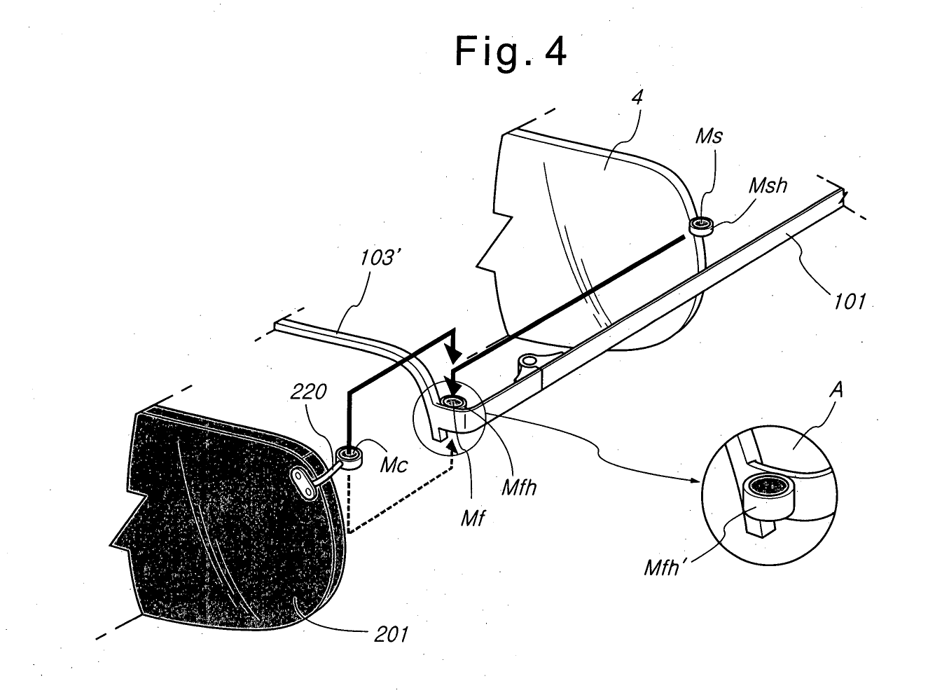

Referring to FIGS. 3 and 4 illustrating the second embodiment of the present invention, the frame unit 100 includes a lens frame 103′ having an inverted U-shaped form with an open lower end. Also, a frame magnet holder Mfh is attached to a rear surface of the hinge leg 110 such that the frame magnet Mf is vertically inserted through the frame magnet holder Mfh, to provide a horizontal magnet attachment plane.

The spectacle unit 1 of the present embodiment, which constitutes the spectacles S in cooperation with the frame magnet Mf, has a frameless structure, and a spectacle magnet holder Msh is fixed at an outer end of each lens 4 to protrude laterally. In this structure, the spectacle magnet Ms is vertically inserted through the spectacle magnet holder Msh, to provide a horizontal magnet attachment plane.

The clip-on 200 of the present embodiment includes a magnet arm 220 fixed to the outer end of each plate-shaped sunshade lens 201, the magnet arm 220 being bent toward the frame unit 100. In this structure, the clip magnet Mc is vertically inserted through the magnet arm 220 at a rear end position of the magnet arm 220.

In the second embodiment of the present invention, the clip magnet Mc, frame magnet Mf, and spectacle magnet Ms are aligned in a vertical line such that the clip magnet Mc and spectacle magnet Ms are attached to the frame magnet Mf at an upper or lower side of the frame magnet Mf as designated by solid and dotted arrows of FIG. 4.

As shown in the circle A of FIG. 4 in enlarged scale, alternatively, a magnet holder Mfh′ for receiving the frame magnet Mf may be attached at a front surface of the hinge leg 110.

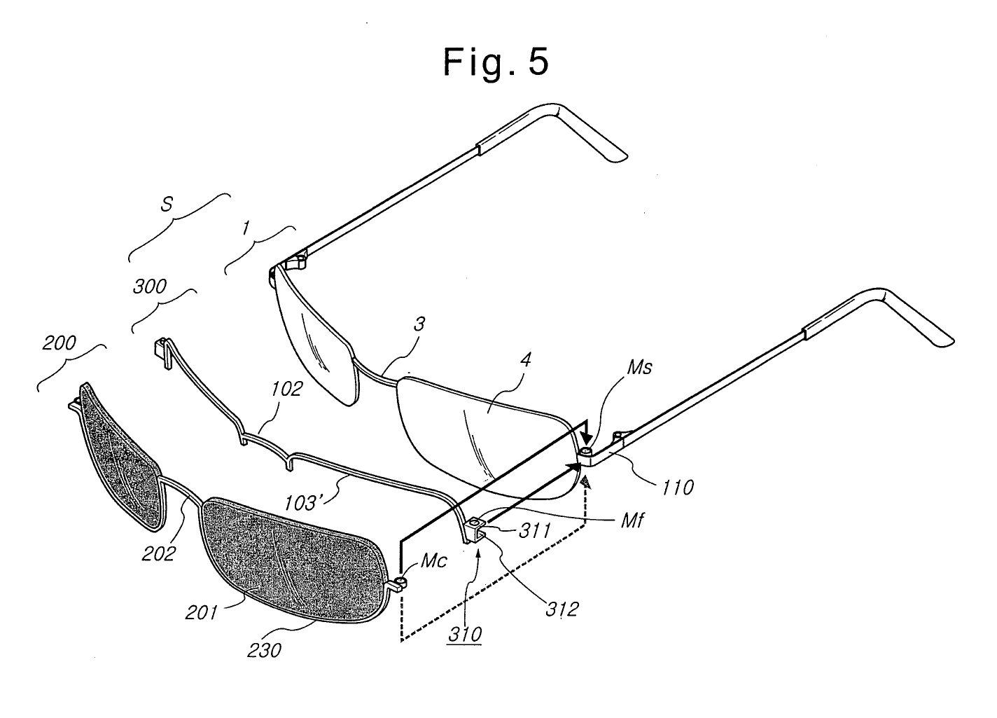

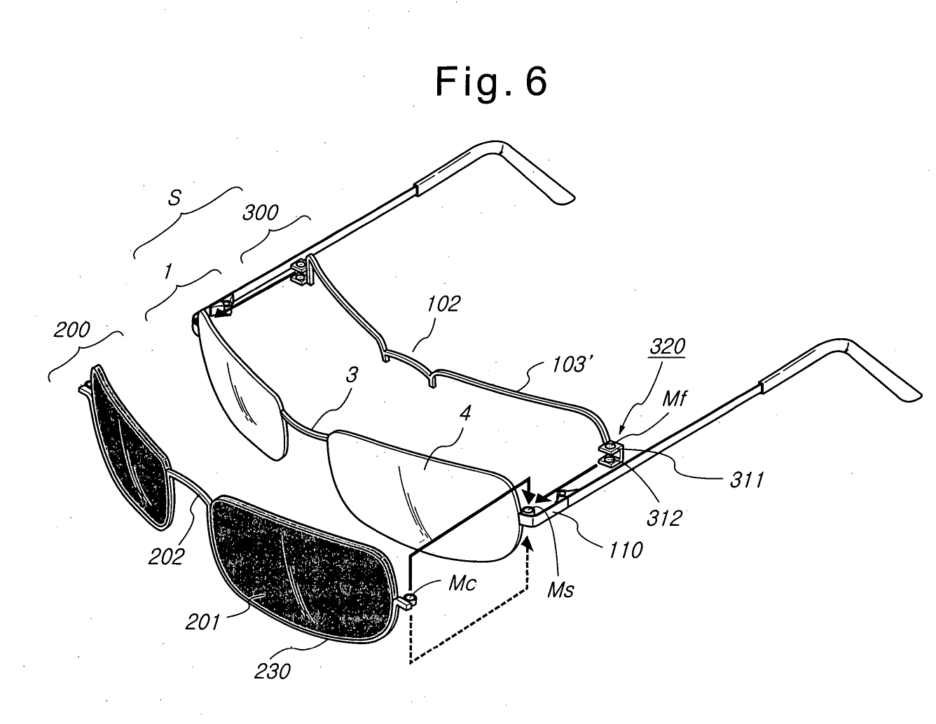

Referring to FIGS. 5 and 6 illustrating the third and fourth embodiments of the present invention, the spectacle unit 1 of the present embodiment takes the form of conventional frameless spectacles, and includes the pair of lenses 4, temple arms 101, and hinge legs 110 used to pivotally connect the lenses 4 to the temple arms 101. The spectacle unit 1 of the present embodiment further includes a spectacle magnet holder Msh horizontally mounted to the rear surface of the hinge leg 110. In this structure, the spectacle magnet Ms is vertically inserted through the spectacle magnet holder Msh, to provide a horizontal magnet attachment plane.

The frame unit 300 of the present embodiment is designed to simply function as a decorative element, and includes the lens frame 103′ having an inverted U-shaped form with an open lower end. Although not shown, it will be understood that the lens frame 103′ of the frame unit 300 may have a U-shaped form with an open upper end. The frame unit 300 of the present embodiment further includes an insert 310 fixed at the outer end of the lens frame 103′. The inert 310 has a 90°-rotated U-shaped form with an open rear end such that the spectacle magnet Ms of the spectacle unit 1 is inserted thereinto. To be detachably attached to the spectacle magnet Ms of the spectacle unit 1, at least one frame magnet Mf is inserted into at least one of upper and lower pieces 311 and 312 of the 90°-rotated U-shaped insert 310.

The clip-on 200 of the present embodiment includes the sunshade lenses 201, and a clip frame 230 configured to receive one of the sunshade lenses 201 through an open upper or lower end. Here, the opening direction of the clip frame 210 is opposite to that of the frame unit 300. In the present embodiment, an outer end of the clip frame 230 forms a protrusion 231 such that a clip magnet holder Mch is attached to a rear surface of the protrusion 231 to face the spectacles S. In this structure, the clip magnet Mc is vertically inserted through the clip magnet holder Mch.

FIG. 6 shows another modified embodiment of that of FIG. 5.

The inert 320 has a 90°-rotated U-shaped form with an open front end such that the spectacle magnet Ms of the spectacle unit 1 is inserted thereinto from the rear direction of spectacle unit 1.

In the present embodiment, the frame unit 300 simply serves as a decorative element for providing the clip-on 200 having an open upper end with a complete spectacle shape when it is coupled to the upper end of the clip-on 200.

As stated above, the above described respective embodiments of the present invention show that the clip magnet Mc, frame magnet Mf, and spectacle magnet Ms are attachable to each other in a specific arrangement selected from among a variety of arrangements including a horizontal front and rear arrangement, vertical upper and lower arrangement, and a combination thereof.

Also, although the plurality of clip magnet Mc, frame magnet Mf, and spectacle magnet Ms are used in the above described embodiments, it can be understood that the same operational effects can be obtained if one of the corresponding attachment elements may be formed of a magnetically-induced material or be magnetized, so as to be attached to the magnet of the other element.

As apparent from the above description, the present invention provides an interchangeable spectacles and clip-on assembly in which a spectacle unit, frame unit, and clip-on can be designed to have a variety of shapes while being freely combined with one another, thereby achieving a variety of designs of the spectacles and clip-on assembly and reducing the overall weight and thickness of the assembly.

Although the preferred embodiment of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An interchangeable spectacles and clip-on assembly comprising:
a spectacle unit including a pair of prescription lenses;
a frame unit configured to be detachably attached to the spectacle unit and adapted to serve as a framework constituting spectacles; and
a clip-on including a pair of sunshade lenses to selectively serve as sunglasses, the clip-on being adapted to be detachably attached to the spectacles that is formed of the spectacle unit and frame unit,
wherein the frame unit includes a pair of U-shaped or inverted U-shaped lens frames having an open upper or lower end and intended so as not to receive lenses, and a frame bridge to connect the lens frames to each other, and
wherein a frame magnet fixed at each outer end and a front or rear surface of the frame unit, a spectacle magnet fixed at each outer end of the spectacle unit, and a clip magnet fixed at each outer end of the clip-on are attached to one another in one or more arrangements selected from among a vertical front and rear arrangement, horizontal upper and lower arrangement, and a combination thereof.

2. The assembly as set forth in claim 1,
wherein the frame magnet is vertically inserted through a frame magnet holder, which is selectively fixed to a front or rear surface of a hinge leg provided at the end of the frame unit,
wherein the spectacle magnet is vertically inserted through a spectacle magnet holder, which is fixed at the end of the spectacle unit to protrude laterally,
wherein the clip magnet is vertically inserted through a magnet arm at a rear end position of the magnet arm, the magnet arm being fixed at the end of the clip-on to be bent toward the frame unit, and
whereby the spectacle magnet and clip magnet are vertically attached to the frame magnet from an upper or lower side of the frame magnet, respectively.

3. The assembly as set forth in claim 1,
wherein the spectacle magnet is vertically inserted through a spectacle magnet holder, which is fixed at a front or rear surface of a hinge leg provided at the end of the spectacle unit,
wherein the frame magnet is vertically inserted through at least one of upper and lower pieces of an insert, which has an approximately 90°-rotated U-shaped form and is fixed at the end of the frame unit,
wherein the clip magnet is vertically inserted through a clip magnet holder, which is fixed at the end of the clip-on to face the spectacles, and
whereby the spectacle magnet and clip magnet are vertically attached to the frame magnet from an upper or lower side of the frame magnet, respectively.

4. The assembly as set forth in claim 1,
wherein the frame magnet is horizontally inserted through a hinge leg, which is provided at the end of the frame unit,
wherein the spectacle magnet is horizontally inserted in a protruding leg, which is fixed at the end of the spectacle unit,
wherein the clip magnet is inserted in a rear surface of a protruding rib, which is fixed at the end of the clip-on, and
whereby the spectacle magnet and clip magnet are horizontally attached to the frame magnet from front and rear sides of the spectacle magnet, respectively.

5. The assembly as set forth in claim 1, wherein the spectacle unit has a frameless form, and the spectacle magnet is fixed to an outer end of the associated lens of the spectacle unit.

6. The assembly as set forth in claim 1, wherein the sunshade lenses of the clip-on, having a plate shape, are connected to each other by use of a clip bridge, or are received in a pair of clip frames having an open upper or lower end, respectively, the opening direction of the clip frame being opposite to the open upper or lower end of each lens frame of the frame unit.

7. The assembly as set forth in claim 1,
wherein the spectacle unit has a frameless structure having no frames for receiving the prescription lenses, and a pair of temple arms are connected to the prescription lenses, respectively, by interposing hinge legs, the spectacle unit being independently usable as spectacles, and
wherein the frame unit including the pair of U-shaped or inverted U-shaped lens frames having an open upper or lower end is configured as a decorative member to be selectively attached to the spectacle unit by use of magnets.
